(19) United States
(12) Patent Application Publication
(10) Pub. No.: US 2025/0109558 A1
(43) Pub. Date: Apr. 3, 2025

(54) BRINE ASSEMBLY FOR A STAND-ON SKID STEER VEHICLE

(71) Applicant: Ariens Company, Brillion, WI (US)

(72) Inventors: Brian Rasmussen, Appleton, WI (US); Mark Nier, Kiel, WI (US); Justin Lodes, New Holstein, WI (US)

(21) Appl. No.: 18/715,662

(22) PCT Filed: Dec. 1, 2022
(86) PCT No.: PCT/US2022/080770

§ 371 Date: May 31, 2024

Related U.S. Application Data
(60) Provisional application No. 63/285,854, filed on Dec. 3, 2021.

(30) Foreign Application Priority Data
Jan. 19, 2022 (CA) 3146185

(51) Int. Cl. E01H 10/00; B62D 11/06; B62D 51/02

(52) U.S. Cl. CPC E01H 10/007; B62D 11/06; B62D 51/02

(57) ABSTRACT

A snow removal utility machine includes a frame having a front end and a rear end, a prime mover supported by the frame, a skid steer drive assembly operably coupled to the prime mover, and one or more ground engaging elements supporting the frame with respect to a ground surface. The ground element being operable under the influence of the skid steer drive assembly to move the utility machine over the ground surface. A brine assembly coupled to the frame and has one or more fluid tanks. The one or more fluid tanks extend around at least three sides of the prime mover.

### CROSS-REFERENCE TO RELATED APPLICATIONS

This application is claims priority to co-pending Canadian Application No. 3,146,185 filed Jan. 19, 2022, which claims priority to U.S. Provisional Patent Application No. 63/285,854 filed on Dec. 3, 2021, the entire contents of all of which are incorporated herein by reference.

### BACKGROUND

The present invention relates to a stand on utility vehicle, such as a snow removal machine, having a brine assembly for dispensing fluid to a surface.

### SUMMARY

In one aspect, the invention provides a snow removal utility vehicle comprising a frame having a front end and a rear end; a prime mover supported by the frame; a skid steer drive assembly operably coupled to the prime mover; one or more ground engaging elements supporting the frame with respect to a ground surface, the ground engaging elements being operable under the influence of the skid steer drive assembly to move the utility machine over the ground surface; and a brine assembly coupled to the frame, the brine assembly having one or more fluid tanks. Wherein the one or more fluid tanks extend around at least three sides of the prime mover.

In another aspect, the invention provides a snow removal utility vehicle comprising a frame having a front end and a rear end; a prime mover supported by the frame; a skid steer drive assembly operably coupled to the prime mover; one or more ground engaging elements supporting the frame with respect to a ground surface, the ground engaging elements being operable under the influence of the skid steer drive assembly to move the utility machine over the ground surface; a brine assembly coupled to the frame, the brine assembly having one or more fluid tanks; and a light assembly coupled to the one or more fluid tanks.

In another aspect, the invention provides a snow removal utility vehicle comprising a frame having a front end and a rear end; a prime mover supported by the frame; a fuel tank positioned on a first side of the vehicle; a skid steer drive assembly operably coupled to the prime mover; one or more ground engaging elements supporting the frame with respect to a ground surface, the ground engaging elements being operable under the influence of the skid steer drive assembly to move the utility machine over the ground surface; and a brine assembly coupled to the frame. The brine assembly including a first fluid tank positioned on a second side of the vehicle, and a second fluid tank extending between the first fluid tank and the fuel tank.

Other aspects of the invention will become apparent by consideration of the detailed description and accompanying drawings.

### BRIEF DESCRIPTION OF THE DRAWINGS

FIG. 1 is a front perspective view of a stand-on snow removal vehicle according to the present invention.

FIG. 2 is a rear perspective view of the stand-on snow removal vehicle of FIG. 1.

FIG. 3 is top view of the stand-on snow removal vehicle of FIG. 1.

FIG. 4 is a bottom view of the stand-on snow removal vehicle of FIG. 1.

FIG. 5 is a side view of the stand-on snow removal vehicle of FIG. 1 with a portion of the vehicle removed to illustrate an implement support assembly.

FIG. 6 is a rear perspective view of the stand-on snow removal vehicle of FIG. 1 having an implement coupled to the implement support assembly and supported in front of the vehicle.

FIG. 7 is an isolated, perspective view of a portion of a brine assembly of the vehicle of FIG. 1, illustrating fluid paths through an outlet hose of the brine assembly.

FIG. 8 is a side cross-sectional view of the vehicle of FIG. 1, illustrating an internal cavity of each brine tank of the brine assembly.

FIG. 9 is a perspective view of a portion of the vehicle of FIG. 1, illustrating a pressure equalizing hose extending between the first and second brine tanks of the brine assembly.

FIG. 10 is a front perspective view of a portion of the vehicle of FIG. 1, illustrating a light assembly.

FIG. 11 is a rear perspective view of a portion of the vehicle of FIG. 1 with a portion of the vehicle removed to illustrate a plurality of nozzles of the brine assembly coupled to the vehicle.

FIG. 12 is a side view of the stand-on snow removal vehicle of FIG. 1 with a portion of the vehicle removed to illustrate the plurality of nozzles coupled to the vehicle.

### DETAILED DESCRIPTION

Before any embodiments of the invention are explained in detail, it is to be understood that the invention is not limited in its application to the details of construction and the arrangement of components set forth in the following description or illustrated in the following drawings. The invention is capable of other embodiments and of being practiced or of being carried out in various ways.

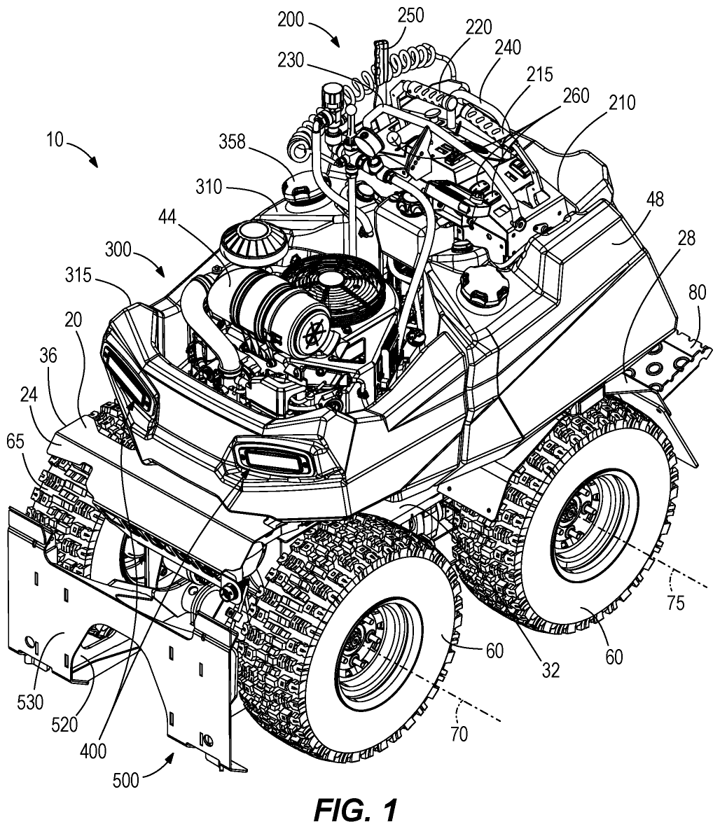

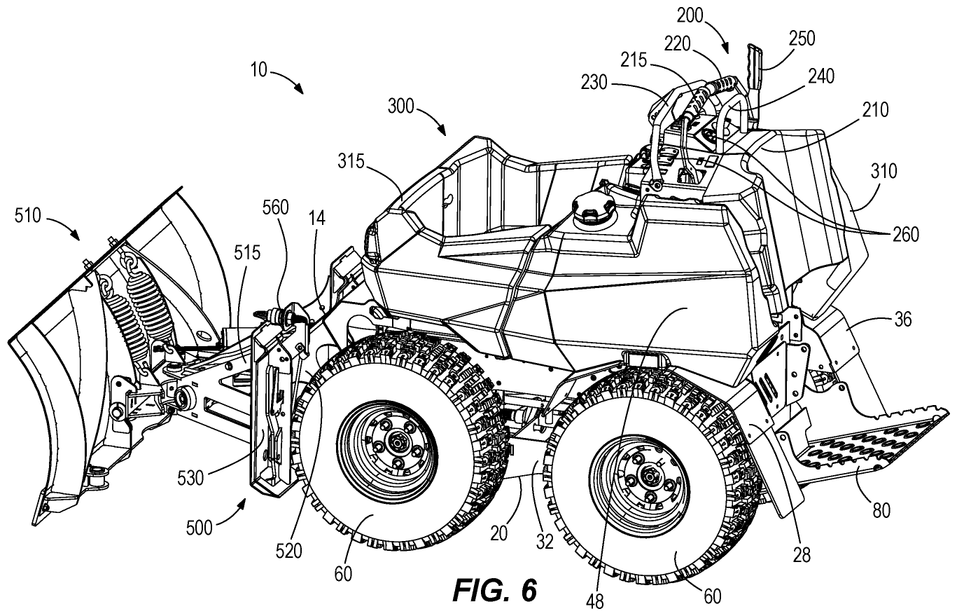

FIGS. 1-6 illustrate an exemplary embodiment of a snow removal vehicle 10 according to the present invention. In the illustrated embodiment, the snow removal vehicle is in the form of a stand-on snow removal vehicle 10 having an implement 510 (FIG. 6) coupled to the vehicle 10.

Although the present invention is described with respect to the illustrated snow removal vehicle, it will be understood that the invention is applicable to other indoor and outdoor power equipment units and more broadly to utility machines that can be used indoors or outdoors to perform work. As such, aspects of the invention which are described as being part of the “vehicle” will be understood to be applicable to utility machines generally and the term “machine” can be substituted to for “vehicle”. Spatial terminology (e.g., “front,” “rear,” “left,” “right,” “forward,” “back,” “up,” “down,” and similar terms) will be used from the perspective of an operator during ordinary, intended operation of the utility machine. The term “side” is used to denote left, right, front and rear of a component, unless otherwise specified, as distinguished from the top and bottom of the component.

Generally speaking, utility machines of the type covered by the present invention include an implement, which encompasses any implement on such utility machine that performs work other than moving the utility machine (e.g., driving rotation of wheels or track drives). In the embodiment illustrated in FIG. 6, the implement 510 comprises a snow plow coupled to and positioned forward of the vehicle 10. In other embodiments, the implement comprises a drop spreader for ice melting particulate (e.g., salt or other snow melting crystals). In some embodiments, the drop spreader may be coupled to and positioned rearward of the vehicle. It should also be appreciated that the utility vehicle 10 may include more than one implement (e.g., both the snow plow and the drop spreader). In other embodiments, the implement comprises a rotating brush. In other embodiments, the implement comprises a snow blower. In other embodiments, the implement comprises leaf blowers, snow blowers, power brush implements, trimmers, tillers, multi-attachment vehicles, floor polishers, vacuum cleaners, wet vacs, concrete trowels, or any other indoor or outdoor work unit suitable for a given application. In other embodiments, the implement comprises combinations of the exemplary implements illustrated in the drawings or mentioned above.

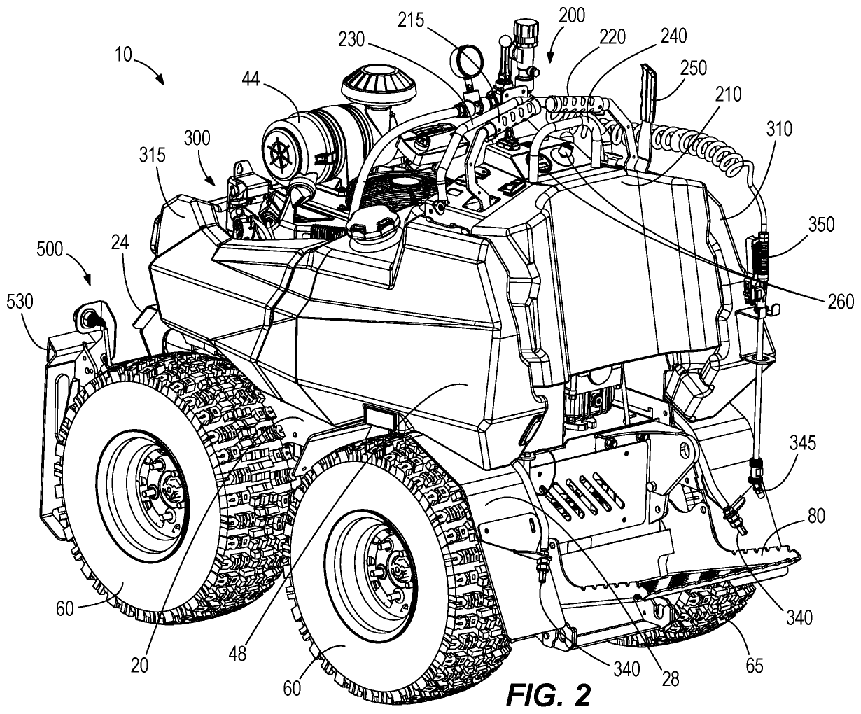

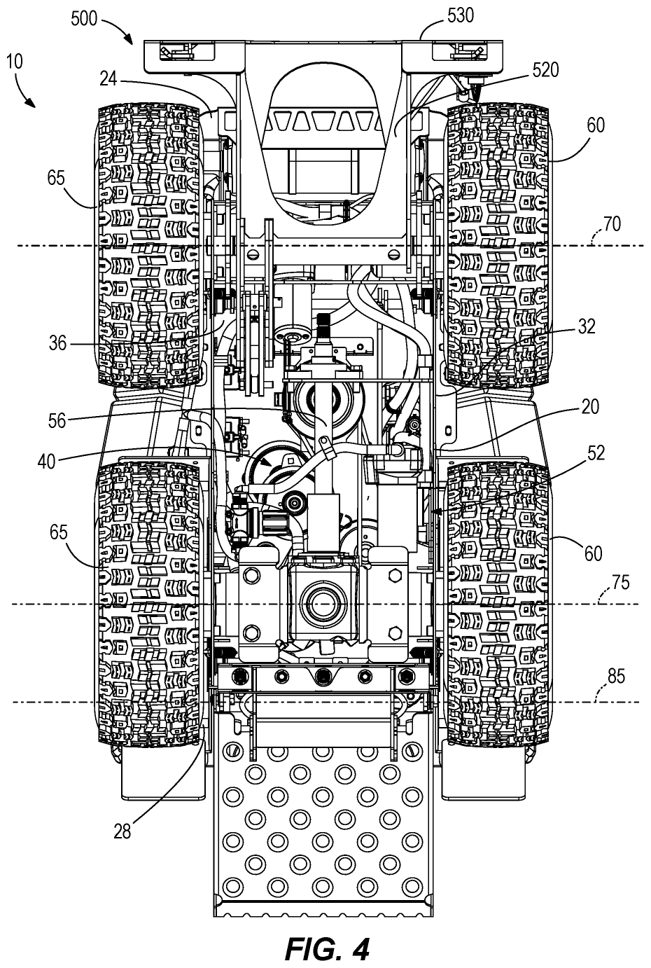

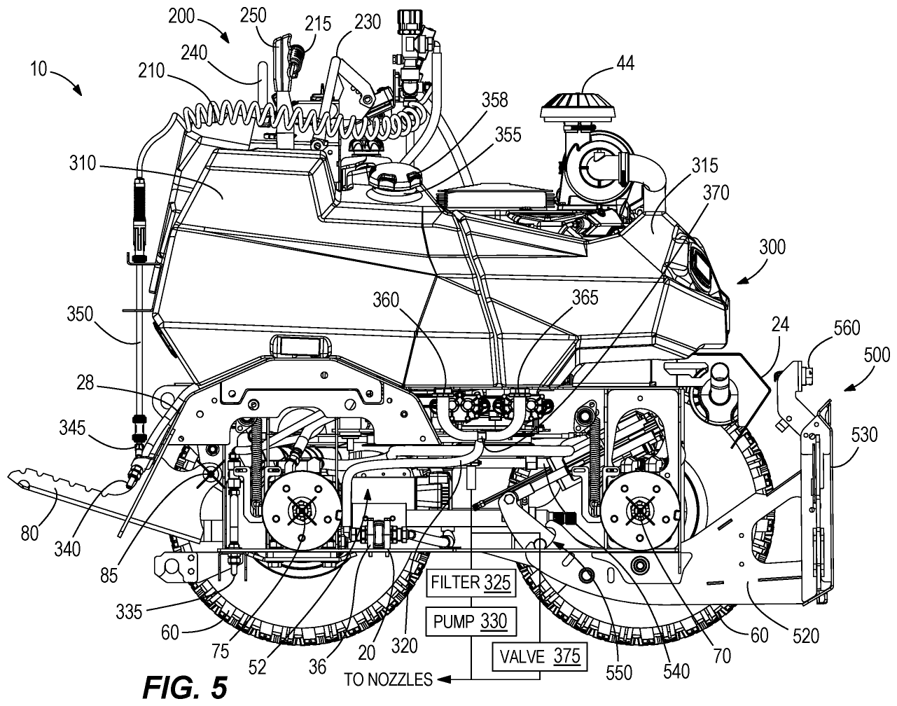

The vehicle 10 includes a frame 20, a skid steer drive assembly 40 (FIG. 4), ground engaging elements 60, 65, an operator platform 80 coupled to the frame 20, an operator interface 200 positioned proximate the operator platform 80, a brine assembly 300 coupled to the frame 20, a light assembly 400 supported relative to the frame 20, and an implement support assembly 500 coupled to the frame 20 and configured to selectively receive the implement 510 (FIG. 6) in front of the frame 20. The frame 20 includes a front end 24 (FIG. 1), a rear end 28 (FIG. 2) opposite the front end, a first or left side 32 (FIG. 1) extending between the front and rear ends, and a second or right side 36 (FIG. 5) extending between the front and rear ends 24, 28.

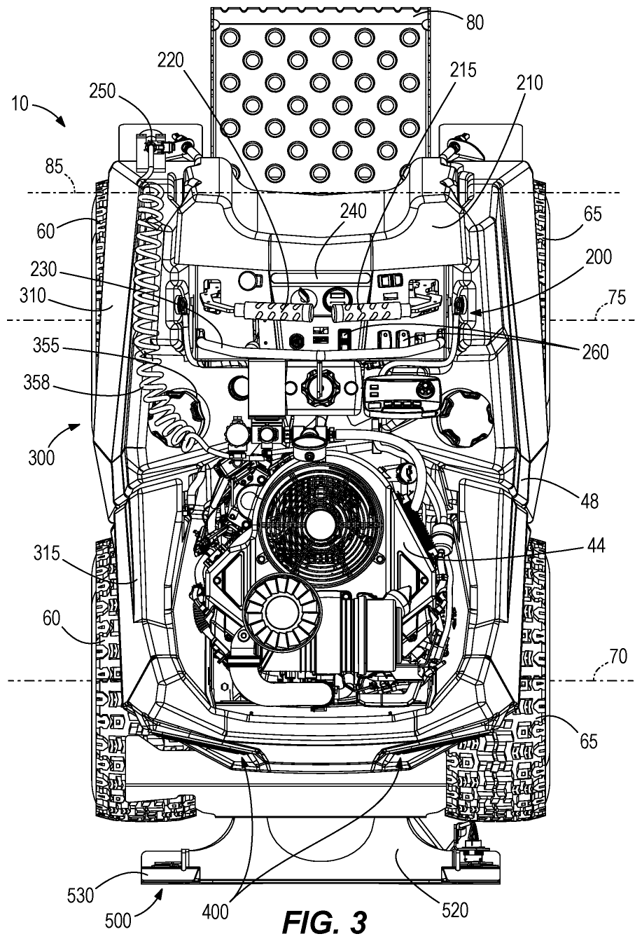

With reference to FIGS. 3 and 4, the skid steer drive assembly 40 (FIG. 4) includes an internal combustion engine 44 (FIG. 3) mounted to the frame 20, a fuel tank 48 (FIG. 3) coupled to the frame 20 to provide fuel to the engine 44, and a hydraulic system 52 (FIG. 4) operably coupled to the ground engaging elements 60, 65. As shown in FIGS. 1 and 3, the internal combustion engine 44 is mounted to a top portion of the frame 20 (e.g., above a front drive axis 70 and a rear drive axis 75 of the ground engaging elements 60, 65). The brine assembly 300 and the fuel tank 48 extend around the front, right side, left side, and a portion of the rear of the engine 44 such that all sides of the engine 44 are substantially enclosed by the brine assembly 300 and fuel tank 48, while the top of the engine 44 is exposed. In some embodiments, a cover may be coupled to the brine assembly 300 to enclose the top of the engine 44. However, it should be appreciated that the top portion of the engine 44 is still exposed relative to the brine assembly 300.

As shown in FIG. 4, the internal combustion engine 44 (FIG. 3) drives the hydraulic system 52 to rotate the ground engaging elements 60, 65 and also drives a rotating output shaft or power takeoff shaft (PTO) 56 that may be coupled to an implement (e.g., such as a snow blower, brushroll, etc.) to drive a work implement member. In some embodiments, the vehicle may include a single reservoir coupled to a two-stage hydraulic pump (e.g., having a single input and two outputs). The hydraulic pump may drive the ground engaging elements 60, 65. In other embodiments, the vehicle 10 may include separate hydraulic pumps and reservoirs to respectively drive the ground engaging elements 60. The hydraulic system 52 also applies the torque to respective left and right ground engaging elements 60, 65 in response to an input from the operator interface 200. In the illustrated embodiment, the ground engaging elements 60, 65 include a pair of left drive wheels 60 (front and rear) and a pair of right drive wheels 65 (front and rear). The left drive wheels 60 are hydraulically coupled and the right drive wheels 65 are hydraulically coupled. “Hydraulically coupled” means that the pairs of wheels 60, 65 are simultaneously and synchronously driven by the hydraulic system 52 and neither of the pair can be driven independently of the other. The drive wheels 60, 65 support the frame 20 and rotate under the influence of the skid steer drive assembly 40 to move the vehicle 10 across the ground surface.

In other embodiments of the invention, the internal combustion engine 44 is replaced with an electric motor or any other suitable prime mover (e.g., a hybrid gas/electric motor, a fuel cell, or any other suitable device operating on a suitable fuel). If a prime mover capable of modulating speed is employed (e.g., an electric motor), the hydraulic system (hydraulic pump and hydraulic motor) can be dispensed with and the primary mover can provide power directly to the differential. In other embodiments the drive wheels 60, 65 could be replaced with track drives or any other suitable tractive elements. Left and right drive shafts of the front wheels are coaxial about the front drive axis 70 and the left and right drive shafts of the rear wheels are coaxial about the rear drive axis 75. The front and rear drive axes 70, 75 can collectively be referred to as the drive shafts of the vehicle 10.

With reference to FIGS. 2 and 4, the operator platform 80 is pivotably coupled to the rear end of the frame 20 and positioned rearward of the frame 20. The operator platform 80 is configured to support an operator in a standing position and provide access to the operator interface 200, which is positioned in front of the operator platform 80. In other words, at least a portion of the operator platform 80 is positioned rearward of the operator interface 200 and a rearward-most ground engaging element 60, 65 (e.g., the rear wheels). The operator platform 80 is pivotally mounted to the frame 20 about an axis 85 (FIG. 4) that is rearward of the rear drive axes 75 and the platform 80 is entirely rearward of the rear drive axes 75. In some embodiments, a suspension system or vibration dampening mechanism may be positioned between the frame 20 and the operator platform 80.

The operator interface 200 is positioned on top of a vertical structure or control tower 210 and is accessible by the operator standing on the platform 80. The operator interface 200 comprises a plurality of handles, levers, switches, or the like which are configured to control operation of one or more components (e.g., drive assembly, interface support assembly, implement, etc.). In the illustrated embodiment, the operator interface 200 includes a pair of control levers 215, 220, a first or front speed limiter 230 and a second or rear speed limiter 240, which respectively restrict forward and rearward movement of the control levers 215, 220. In the illustrated embodiment, the first speed limiter 230 is pivotably coupled on top of the control tower 210, which allows the operator to adjust the forward range of the control levers 215, 220 and therefore the speed of the vehicle 10. The operator interface 200 also includes a parking brake 250 to selectively restrict movement of the vehicle 10 and one or more hand controls 260. The hand controls 260 may include multiple functions that can be manipulated by the operator's hands. Some examples of hand controls 260 include: an implement control for transmitting power from the engine 44 to adjust the position of the interface support assembly, a brine control to dispense brine from the brine assembly 300, a light switch, an engine throttle, an engine choke, an engine kill switch, and a hydraulic motor or pump control for controlling the speed and direction of operation of the drive wheels 60, 65. In other constructions, the hand controls 260 may include additional controls to operate other implements coupled to vehicle 10.

As shown in FIGS. 3-5, the brine assembly 300 is coupled to the frame 20 forward of at least a portion of the operator platform 80. In the illustrated embodiment, the brine assembly 300 includes a first fluid or brine tank 310, a second fluid or brine tank 315 that is in fluid communication with first brine tank 310, an outlet hose 320 in fluid communication with both the first and second brine tanks 310, 315, a filter 325 (schematically illustrated in FIG. 5) coupled to the outlet hose 320 downstream the brine tanks 310, 315, a pump 330 (schematically illustrated in FIG. 5) coupled to the outlet hose 320 downstream the filter 325, and a one or more of nozzles 335, 340, 345 coupled to the outlet hose 320 downstream the pump 330. In other embodiments, the brine assembly 300 may include a single brine tank. The pump 330 draws the fluid from the brine tanks 310, 315 through the outlet hose 320 to dispense the fluid through the nozzles 335, 340, 345. The nozzles 335, 340, 345 are coupled to the vehicle 10 rearward of the ground engaging elements 60, 65 to disperse the fluid behind the vehicle 10 during operation. Further, the plurality of nozzles 335, 340 are rigidly coupled to the vehicle 10 and the nozzle 345 is coupled to a hand wand 350 that is removably coupled to the vehicle 10. The hand wand 350 is coupled to the vehicle 10 proximate the operator platform 80 so the operator can selectively dispense brine to a desired area surrounding the vehicle 10.

The first brine tank 310 includes an inlet 355 having a cap 358 removably coupled thereto. The inlet 355 is configured to receive a fluid (e.g., brine). Each of the first and second brine tanks 310, 315 includes an outlet 360, 365 (FIG. 5) with the outlet hose 320 coupled thereto. In the illustrated embodiment, the outlet hose 320 includes a three-way junction 370 positioned between the outlets 360, 365 of the brine tanks 310, 315 and the filter 325, which allows fluid to move between the first and second brine tanks 310, 315 and through the filter 325 to the pump 330. In some embodiments, a valve 375 (schematically illustrated) may be positioned between the brine tanks 310, 315 and the filter 325. The valve 375 allows the operator to prevent fluid flow from the brine tanks 310, 315 so the operator can replace the filter 325 without emptying the brine tanks 310, 315. In some embodiments, a second valve may be positioned between the pump 330 and the nozzles 335, 340, 345 to prevent the backflow of fluid through the outlet hose 320 during replacement of the filter 325.

As shown in FIGS. 5 and 6, the implement support assembly 500 is pivotably coupled to the front end 24 of the frame 20. The implement support assembly 500 is configured to removably receive the implement 510 (FIG. 6) such as a snowplow having an implement arm 515. The implement support assembly 500 includes an interface support frame 520 pivotably coupled to the vehicle frame 20, an implement interface 530 coupled to the interface support frame 520 and configured to receive the implement arm 515 of the implement 510 (FIG. 6), and a hydraulic cylinder 540 (FIG. 5) having a first end coupled to the vehicle frame 20 and a second end coupled to the interface support frame 520 through a float feature 550. The hydraulic cylinder 540 is configured to adjust the position (e.g. vertical or pitch position) of the interface support frame 520 and the implement 510 in response to an input from the operator interface 200. In the illustrated embodiment, the hydraulic cylinder 540 is an electric over hydraulic actuator. The implement support assembly 500 further includes an electrical connector 560 supported relative to the interface support frame 520. The electrical connector 560 may be coupled to the implement 510 to drive a working member of the implement. In some embodiments, the implement (e.g., such as a plow) may include a secondary hydraulic cylinder coupled to the electrical connector 560, which allows the operator to adjust a yaw position of the implement 510 (e.g., using the operator interface 200). In other embodiments, the implement (e.g., such as a snow blower, brushroll, etc.) may include an output or work shaft that is coupled to the PTO shaft 56 to drive a working member (e.g., snow blower, brush roll, etc.) of the implement, which allows the operator to selectively activate the working member of the implement to perform a function.

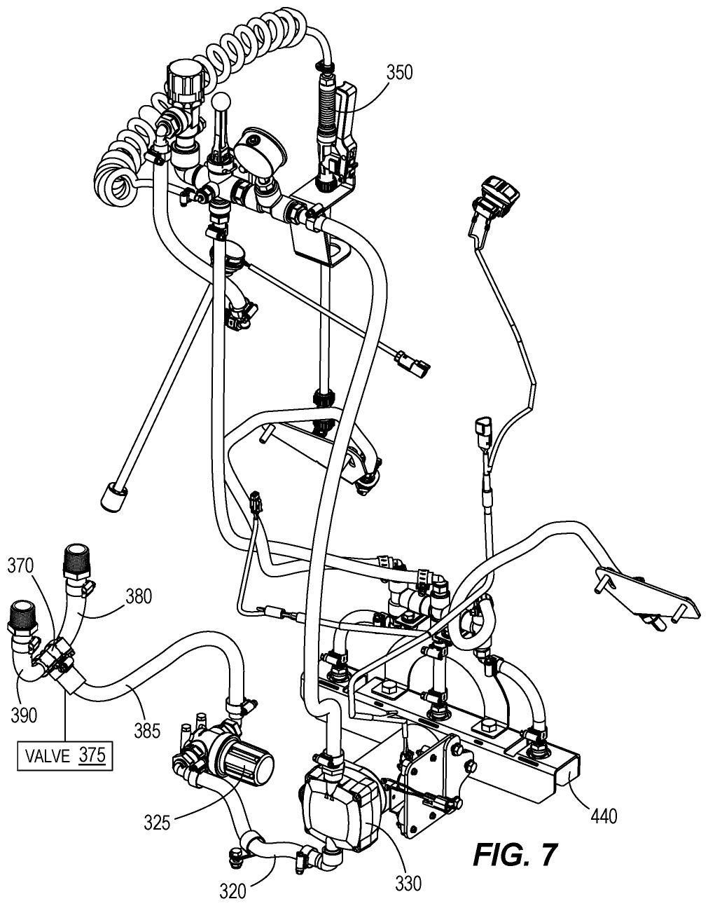

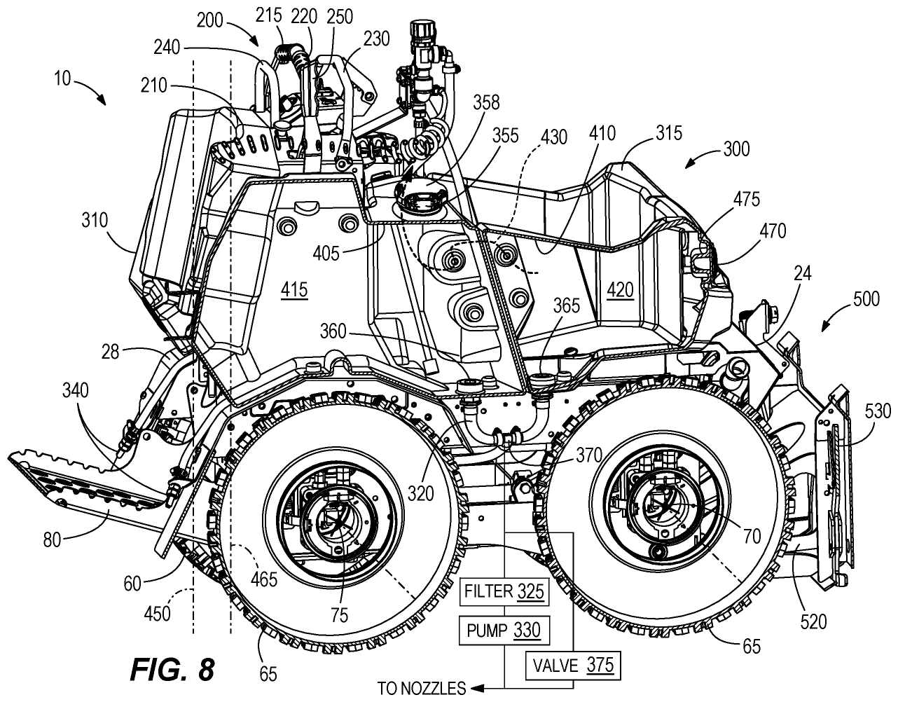

Now with reference to FIGS. 7-12, the brine assembly 300 is illustrated in more detail. With particular reference to FIGS. 7 and 8, fluid paths for the brine assembly 300 from the brine tanks 310, 315 to the plurality of nozzles 335, 340 and the nozzle 345 on the hand wand 350 are illustrated. The three-way junction 370 is positioned between the outlets 360, 365 of the brine tank 310, 315 (FIG. 8) and the filter 325, which allows fluid to move between the first and second brine tanks 310, 315 and through the filter 325 to the pump 330. For example, when the brine tanks 310, 315 (FIG. 8) are filled through the inlet 355 in the first brine tank 310, the fluid flows through the outlet 360 in the first brine tank 310, and through a first section 380 of the three-way junction 370 of the outlet hose 320. When the fluid reaches a second section 385 of the three-way junction 370, fluid flows towards the pump 330, which primes the pump 330. Additionally, when the pump is not operating, fluid backs up in the three-way junction 370 and flows through a third section 390 into the outlet 365 in the second brine tank 315 to fill the second brine tank 315 from the bottom. In other words, the outlet 360 functions as both and outlet for filling the second brine tank 315 from the first brine tank 310 and an outlet to the pump 330, and the outlet 365 of the second brine tank 315 functions as both an inlet and an outlet for the second brine tank 315.

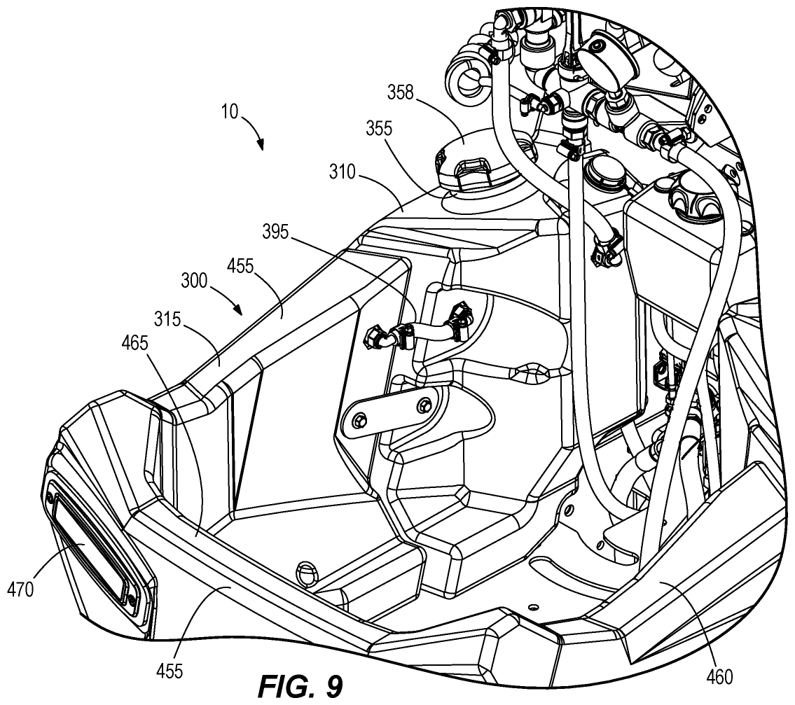

As shown in FIGS. 8 and 9, a pressure equalizing hose 395 (FIG. 9) extends between upper portions of the first and second brine tanks 310, 315 of the brine assembly 300. The pressure equalizing hose 395 is positioned proximate an upper wall 405, 410 of an internal cavity 415, 420 of each of the brine tanks 310, 315. As the brine tanks 310, 315 are being filled, pressure in the second brine tank 315 increases as fluid begins to flow into the second brine tank 315 through the outlet 365 in. As the pressure increases, the pressure is released through the pressure equalizing hose 395 and out of the inlet 355 (schematically shown in FIG. 8 along a path 430).

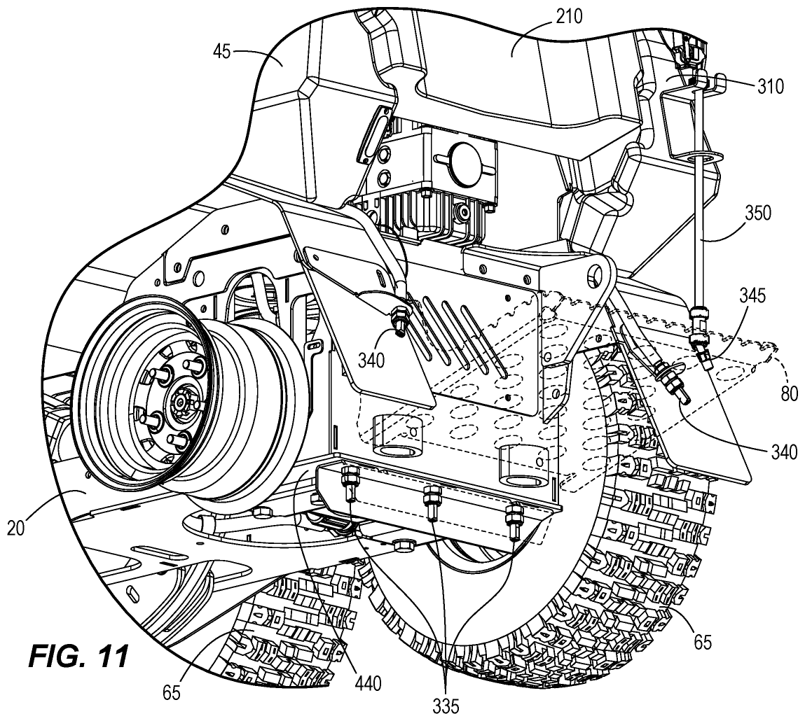

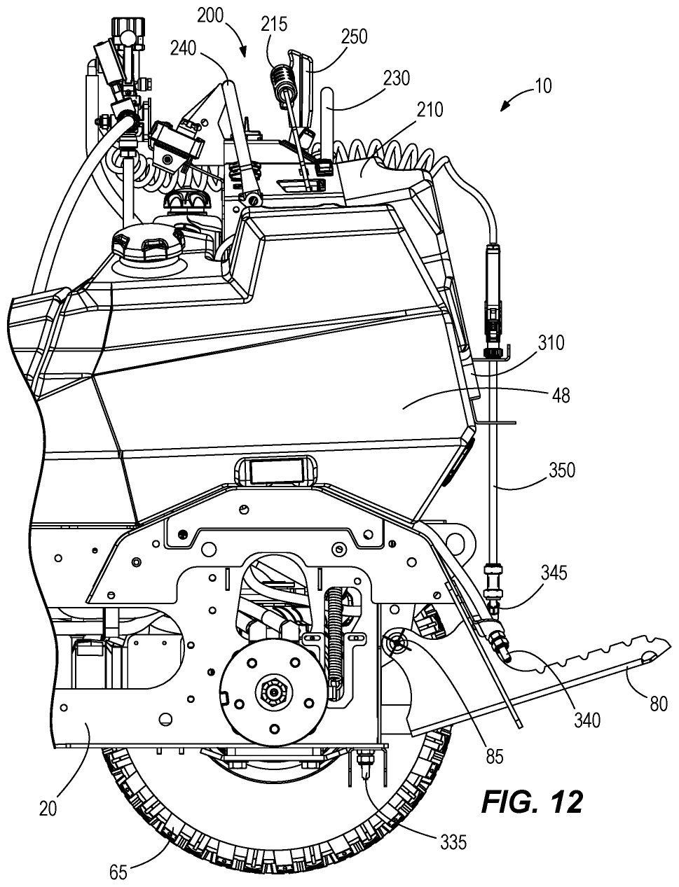

Now with reference to FIGS. 7, 11, and 12, the outlet hose 320 is in fluid communication with the plurality of nozzles 335, 340, 345. In the illustrated embodiment, the vehicle 10 includes five nozzles 335, 340 rigidly coupled to the frame 20 of the vehicle 10 and another nozzle 345 coupled to the hand wand 350 that is removably coupled to the vehicle 10 proximate the operator platform 80 (FIGS. 11 and 12). The pump 330 is configured to draw fluid from the brine tanks 310, 315 and force the fluid under elevated pressure through the nozzle 345 on the hand wand 350 and the nozzles 335, 340 in response to an input from the operator interface 200. In the illustrated embodiment, three nozzles 335 are coupled to a support structure 440 positioned below the operator platform 80, and a pair of nozzles 340 positioned on each side of the operator platform 80. The three nozzles 335 are positioned (i.e., direct fluid) perpendicular to a ground surface the vehicle 10 is traversing. The pair of nozzles 340 are positioned (i.e., direct fluid) at an angle relative to the ground surface (e.g., an obtuse angle). The brine from the nozzles 335, 340 is therefore dispensed rearward of the rear drive axis 75. In other embodiments, the vehicle may include fewer (e.g., four, three, etc.) or more (e.g., six, seven, etc.) nozzles.

Now with reference to FIGS. 1 and 8, the brine tanks 310, 315 of the brine assembly 300 and the fuel tank 48 are positioned in front of a portion of the operator platform 80 and the rearward most ground engaging elements 60, 65. For example, a majority of the brine tanks 310, 315 and the fuel tank 48 are positioned in front of a first plane 445 (FIG. 8) defined by a forwardmost edge of the operator platform 80 and a second plane 450 (FIG. 8) defined by a rearward most edge of the ground engaging elements 60, 65. A majority of the brine tanks 310, 315 and the fuel tank 48 is defined as at least 50 percent of a volume of the fuel tank 48 or the brine tanks 310, 315. In the illustrated embodiment, at least 80 percent (by contained volume) of each of the first brine tank 310 and the fuel tank 48 are positioned in front of the first and second planes 445, 450. Further, the first brine tank 310 and fuel tank 48 are mirror images of each other or include a substantially similar construction and extend along opposing sides of the operator interface 200. The first brine tank 310 and the fuel tank 48 can therefore be molded (e.g., blow molded) from the same mold. In addition, the construction of the first brine tank 310 and the fuel tank 48 balances the weight of the fuel and the brine on each side of the vehicle 10.

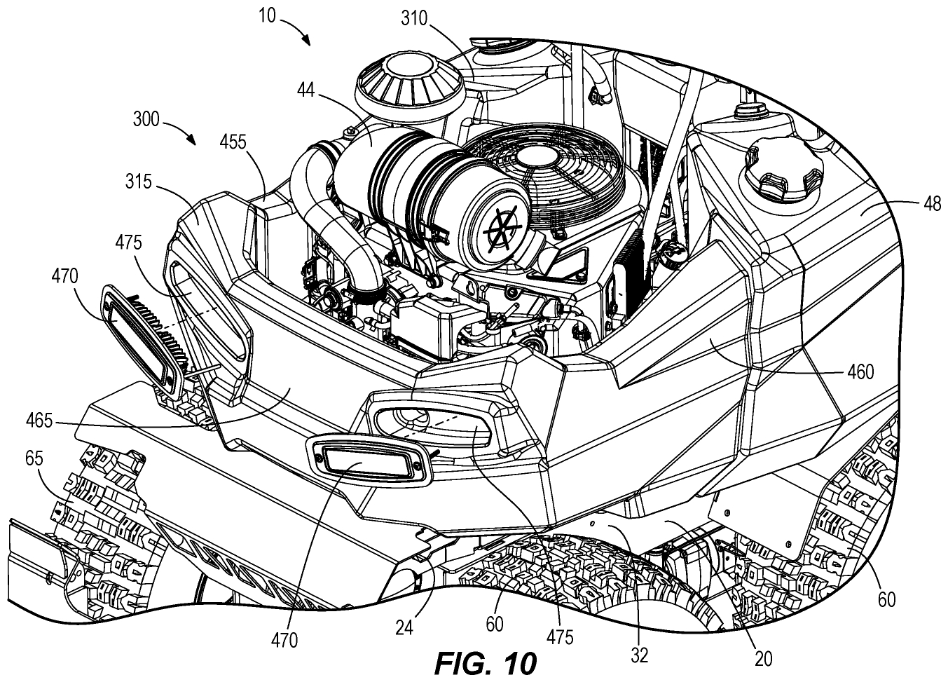

Now with reference to FIG. 10, the second brine tank 315 has a substantially u-shaped geometry that extends around the internal combustion engine 44 and extends between the first brine tank 310 and the fuel tank 48. It should be appreciated that “extending between” may encompass any geometry of the second brine tank 315 that includes a first portion of the second brine tank 315 proximate the first brine tank 310 and a second portion proximate the fuel tank 48. In the illustrated embodiment, the second brine tank 315 includes a first leg portion 455 proximate the first brine tank 310, a second leg portion 460 proximate the fuel tank 48, and a front portion 465 connecting the first and second leg portions 455, 460. Each of the front portion 465, first leg portion 455 and second leg portion 460 defines a portion of the interior volume of the second brine tank 315 such that together they define a U-shaped interior volume for brine. The second brine tank 315, therefore, extends around three sides (e.g., left, right, and front sides) of the engine 44 while the first brine tank 310, the fuel tank 48, and the control tower 210 (FIG. 3) extends around a fourth side of the engine 44 (e.g., a rear side). In other words, the combination of the brine tanks 310, 315, the fuel tank 48, and the control tower 210 surround the engine 44 so only a top portion of the engine 44 is exposed. Exposing a top portion of the engine 44 allows air to enter the engine 44 (e.g., for combustion), while insulating the remainder of the engine 44. Additionally, heat from the engine 44 is transferred to brine in the brine tanks 310, 315 to reduce the likelihood or incidence of the brine slushing in very cold conditions.

As shown in FIGS. 8 and 10, the light assembly 400 is coupled to the second brine tank 315. In particular, the light assembly 400 includes a pair of lights 470 (FIG. 10) that are each supported within the front portion 465 of the second brine tank 315. For example, the lights 470 are secured within respective recesses 475 formed in the front portion 465 of the second brine tank 315. In other words, the lights 470 are embedded within or recessed into the second brine tank 315. Further, in the illustrated embodiment, each light 470 is secured to the second brine tank 315 through a snap fit arrangement. In other embodiments, the lights 470 may be secured to the brine tank 315 in an alternative fashion (e.g., fasteners, etc.). In the illustrated embodiment and other embodiments, the lights 470 can be replaced independently of the second brine tank 315.

1. A snow removal utility machine comprising:
a frame having a front end and a rear end;
a prime mover supported by the frame;
a skid steer drive assembly operably coupled to the prime mover;
one or more ground engaging elements supporting the frame with respect to a ground surface, the ground engaging elements being operable under the influence of the skid steer drive assembly to move the utility machine over the ground surface; and
a brine assembly coupled to the frame, the brine assembly having one or more fluid tanks,
wherein the one or more fluid tanks extend around at least three sides of the prime mover.

2. The utility machine of claim 1, further comprising
an operator platform coupled to the frame and positioned rearward of the ground engaging elements, and
an operator interface positioned on top of a control tower, and
wherein the operator platform is configured to support an operator so the operator interface is accessible by the operator standing on the platform.

3. The utility machine of claim 1, wherein the prime mover is an internal combustion engine, and wherein a fuel tank is supported by the frame and configured to provide fuel to the internal combustion engine.

4. The utility machine of claim 3, wherein the one or more fluid tanks includes
a first fluid tank positioned on a first side of the machine,
a second fluid tank fluidly connected to the first fluid tank.

5. The utility machine of claim 4, wherein the first fluid tank and the fuel tank are substantially identical.

6. The utility machine of claim 4, wherein
the fuel tank is positioned on a second side of the machine, and
the second fluid tank extends between the first fluid tank and the fuel tank.

7. The utility machine of claim 6, wherein the second fluid tank includes a first leg portion proximate the first fluid tank, a second leg portion proximate the fuel tank, and a connecting portion extending between the first and second leg portions.

8. The utility machine of claim 7, wherein the second fluid tank has a u-shaped geometry.

9. The utility machine of claim 1, wherein the one or more fluid tanks extends around prime mover so a top portion of the prime mover is exposed relative to brine assembly.

10. The utility machine of claim 1, further comprising an implement interface assembly coupled to the frame and supported in front of the ground engaging elements, and wherein the implement interface assembly is configured to removably receive an implement.

11. The utility machine of claim 10, wherein the implement is a snow plow.

12. A snow removal utility machine comprising:
a frame having a front end and a rear end;
a prime mover supported by the frame;
a skid steer drive assembly operably coupled to the prime mover;
one or more ground engaging elements supporting the frame with respect to a ground surface, the ground engaging elements being operable under the influence of the skid steer drive assembly to move the utility machine over the ground surface;
a brine assembly coupled to the frame, the brine assembly having one or more fluid tanks; and
a light assembly secured within a recess formed on a front portion of the one or more fluid tanks.

13. The utility machine of claim 12, further comprising
an operator platform coupled to the frame and positioned rearward of the ground engaging elements, and
an operator interface positioned on top of a control tower, and
wherein the operator platform is configured to support an operator so the operator interface is accessible by the operator standing on the platform.

14. The utility machine of claim 12, wherein the recess is a first recess and a second recess is formed on the front portion of the one or more fluid tanks, wherein the light assembly includes a pair of lights that are each secured within respective first and second recesses formed in the one or more fluid tanks.

15. The utility machine of claim 14, wherein the one or more fluid tanks includes
a first fluid tank positioned on a first side of the machine, and
a second fluid tank fluidly connected to the first fluid tank, wherein the first and second recesses are formed in the front portion of the second fluid tank.

16. The utility machine of claim 15, wherein the second fluid tank includes a first leg portion proximate the first fluid tank, a second leg portion proximate a fuel tank, and a connecting portion extending between the first and second leg portions and defining the front portion of the second fluid tank.

17. A snow removal utility machine comprising:
a frame having a front end and a rear end;
a prime mover supported by the frame;
a fuel tank positioned on a first side of the machine;
a skid steer drive assembly operably coupled to the prime mover;
one or more ground engaging elements supporting the frame with respect to a ground surface, the ground engaging elements being operable under the influence of the skid steer drive assembly to move the utility machine over the ground surface; and
a brine assembly coupled to the frame, the brine assembly including:
a first fluid tank positioned on a second side of the machine, and
a second fluid tank extending between the first fluid tank and the fuel tank,
wherein the second fluid tank includes a first leg portion proximate the first fluid tank, a second leg portion proximate the fuel tank, and a connecting portion extending between the first and second leg portions.

18. The utility machine of claim 17, further comprising
an operator platform coupled to the frame and positioned rearward of the ground engaging elements, and
an operator interface positioned on top of a control tower, and
wherein the operator platform is configured to support an operator so the operator interface is accessible by the operator standing on the platform.

19. The utility machine of claim 17, wherein the first fluid tank and the fuel tank are substantially identical.

20. (canceled)
